(19) United States
(12) Patent Application Publication
(10) Pub. No.: US 2025/0353387 A1
(43) Pub. Date: Nov. 20, 2025

(54) HIGH-POWER ELECTRIC VEHICLE CHARGING SYSTEMS AND METHODS

(71) Applicant: COULOMB SOLUTIONS, INC., LIVERMORE, CA (US)

(72) Inventors: DAVID MICHAEL MAZAIKA, MILPITAS, CA (US); LINING ZHOU, MILPITAS, CA (US); NICOLAS BOUCHON, LIVERMORE, CA (US)

(73) Assignee: COULOMB SOLUTIONS, INC., LIVERMORE, CA (US)

(21) Appl. No.: 19/212,408

(22) Filed: May 19, 2025

Related U.S. Application Data
(60) Provisional application No. 63/649,859, filed on May 20, 2024.

(51) Int. Cl. B60L 53/10; B60L 53/16; B60L 53/20; B60L 53/66; B60L 53/67

(52) U.S. Cl. CPC B60L 53/11; B60L 53/16; B60L 53/20; B60L 53/66; B60L 53/67; B60L 2200/36; B60L 2210/30

(57) ABSTRACT

Described herein is a method of high-power direct current (DC) charging of at least one vehicle battery. The method includes connecting an electric vehicle supply equipment (EVSE) to a vehicle charging system using a high-power connector. A handshake is performed between the EVSE and the vehicle charging system to initiate supply of AC power from the EVSE to the vehicle charging system via the high-power connector. The AC power is converted to DC power in excess of 19.2 kW by at least one on-board charger in the vehicle charging system. At least one vehicle battery is charged using the DC power in excess of 19.2 kW.

### RELATED APPLICATION

This application is a U.S. Non-Provisional application of U.S. Provisional Application No. 63/649,859, filed May 20, 2024. The disclosure of this priority is incorporated by reference herein in its entirety.

### TECHNICAL FIELD

The present disclosure generally relates to high-power electric vehicle charging. The present disclosure generally relates to leveraging an existing infrastructure, without the need to add or build additional power grid infrastructure, to charge with high-power.

### BACKGROUND

Vehicles that run on battery power, such as hybrid vehicles and electric vehicles, are becoming increasingly popular. Such vehicles provide a number of advantages over vehicles that do not utilize battery power. For example, such vehicles save drivers money, as no fuel is required. Such vehicles are also environmentally friendly as they do not emit pollutants. However, some electric vehicles may need to power a large quantity of components and/or drive long distances. It can be difficult to efficiently charge the batteries for these electric vehicles. Therefore, improved techniques for charging electric vehicle batteries are desirable.

### SUMMARY OF ASPECTS OF DISCLOSURE

Systems and methods are disclosed herein for high-power electric vehicle charging. A method of high-power direct current (DC) charging of at least one vehicle can include connecting an electric vehicle supply equipment (EVSE) to a vehicle charging system using a high-power connector. A handshake can be performed between the EVSE and the vehicle charging system to initiate supply of alternating current (AC) power from the EVSE to the vehicle charging system via the high-power connector. The AC power can be converted to DC power in excess of 19.2 kW by at least one on-board charger in the vehicle charging system. At least one vehicle battery of the vehicle charging system can be charged using the DC power in excess of 19.2 kW.

A high-power direct current (DC) charging system can include an EVSE, a vehicle charging system, and a high-power connector configured to connect the ESVE to the vehicle charging system. The vehicle charging system can include at least one on-board charger and at least one vehicle battery. The ESVE can be configured to initiate supply of AC power from the EVSE to the vehicle charging system via the high-power connector based on a handshake performed between the EVSE and the vehicle charging system. The at least one on-board charger can be configured to convert the AC power to DC power in excess of 19.2 kW. The at least one vehicle battery can be charged using the DC power in excess of 19.2 kW.

This Summary is provided to introduce a selection of concepts in a simplified form that are further described below in the Disclosure. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system for high-power electric vehicle charging.

FIG. 2 shows an example system for high-power electric vehicle charging.

FIG. 3 shows an example connection between an electric vehicle supply equipment (EVSE) and a vehicle charging system.

FIG. 4 shows another example connection between an electric vehicle supply equipment (EVSE) and a vehicle charging system.

FIG. 5 illustrates an example method for high-power direct current (DC) electric vehicle charging.

FIG. 6 illustrates an example method for load balancing between multiple on-board chargers in a vehicle charging system.

FIG. 7 illustrates an example method for initiating a supply of power from an EVSE to a vehicle charging system.

FIG. 8 illustrates an example computing device.

### DISCLOSURE

Presently disclosed are aspects of systems and methods for the high-power charging of electric vehicle batteries. Historically, electric vehicle connectors (e.g., plugs), such as Combined Charging System (CCS) or CCS combo connectors, have been capable of providing up to 19.2 kW of AC power to a vehicle charging system. While newer, high-power connectors, such as North American Charging System (NACS) connectors, have been developed that are capable of carrying the higher currents needed for AC power charging in excess of 19.2 kW, existing EVSEs and/or existing on-board vehicle charging systems are unable to support such high-power charging. For example, existing EVSEs are unable to put out greater than 19.2 kW of AC power. Further, many existing on-board vehicle charging systems are unable to receive AC power in excess of 19.2 kW and convert such AC power to the DC power necessary for charging the vehicle batteries. As such, improved techniques for high-power electric vehicle charging are needed.

Described herein is a method of high-power DC charging of at least one vehicle can include connecting an electric vehicle supply equipment (EVSE) to a vehicle charging system using a high-power connector. The EVSE can include upgraded hardware, such as high-power rated relays and thicker busbars, that enables the EVSE to put out greater than 19.2 kW of AC power. A handshake can be performed between the EVSE and the vehicle charging system to initiate supply of alternating current (AC) power from the EVSE to the vehicle charging system via the high-power connector. For example, to perform the handshake between the EVSE and the vehicle charging system, the EVSE can send a signal indicating that the EVSE is capable of high-power charging, such as a signal indicating that the EVSE is configured to supply greater than 80 amps of current. If the electric vehicle charging system recognizes the signal, the EVSE can initiate the high-power charging process. The AC power can be converted to DC power in excess of 19.2 kW by at least one on-board charger in the vehicle charging system. At least one vehicle battery of the vehicle charging system can be charged using the DC power in excess of 19.2 kW. If the electric vehicle charging system does not recognize the signal, this can indicate that the vehicle the charging system does not support high-power charging. The EVSE can therefore initiate a conventional, lower-power charging process.

Through this particular method, existing electric vehicle charging infrastructure, such as existing high-power NACS connectors, can be leveraged to efficiently provide AC power in excess of 19.2 kW to an on-board electric vehicle charging system. For example, the techniques described herein can be used to cut the charge time for a large electric vehicle, such as an electric truck of semi-truck, approximately in half (e.g., 10-12 hours as compared to 20 hours) without requiring a replacement of the infrastructure. While DC fast chargers can be used to quickly charge these large electric vehicles, DC fast chargers are difficult to install. Further, DC fast charging is expensive and can cause the batteries in the electric vehicle to heat up, thereby degrading the batteries. Given these downsides to DC fast charging, the techniques for efficiently providing AC power in excess of 19.2 kW to electric vehicle charging systems described herein are particularly desirable.

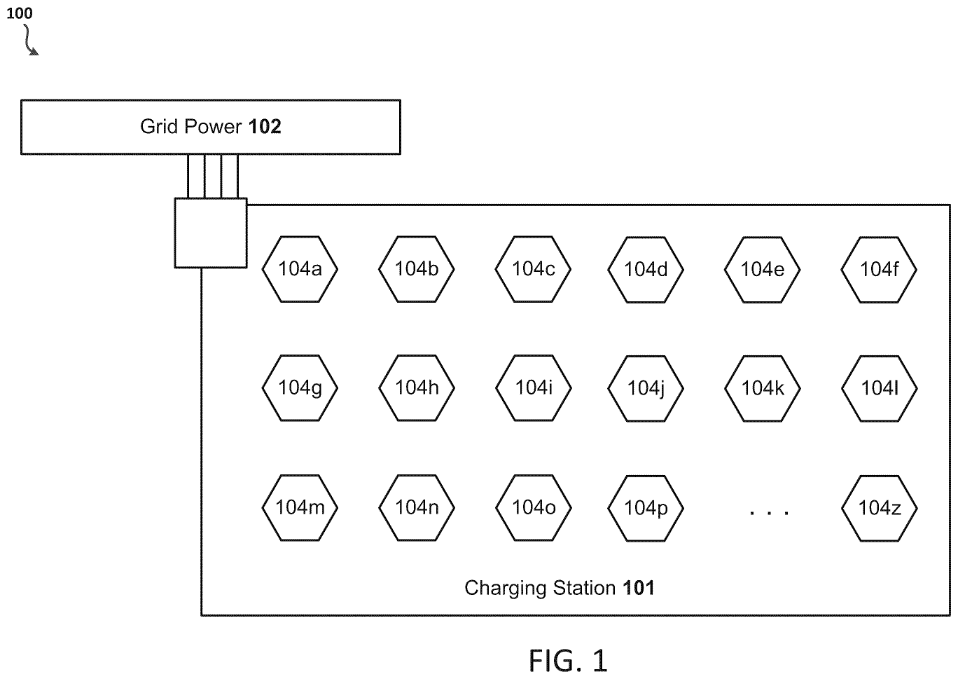

FIG. 1 shows a system 100 for charging electric vehicles. The system 100 includes a charging station 101 and power grid 102. The charging station 101 includes a plurality of EVSEs 104a-z. Each of the plurality of EVSEs 104a-z can include one or more devices configured to provide electric power to a vehicle for recharging the batteries of the vehicle. Each of the plurality of EVSEs 104a-z can include the electrical conductors, related equipment, software, and communications protocols that deliver the energy efficiently and safely to the vehicle. The plurality of EVSEs 104a-z can include any quantity of EVSEs.

Each of the plurality of EVSEs 104a-z can interface with the power grid 102. The power grid 102 may be part of an electrical grid of a city, town, or other geographic region. Using the power grid 102, the plurality of EVSEs 104a-z can provide power to various electric vehicles, including electric trucks, electric semi-trucks, electric vans, etc. Each of the plurality of EVSEs 104a-z can be configured to supply the high current needed for AC power charging in excess of 19.2 kW. For example, each of the plurality of EVSEs 104a-z can be configured to supply greater than 80 amps of current. Each of the plurality of EVSEs 104a-z can include upgraded hardware, such as high-power rated relays and thicker busbars, that enable the plurality of EVSEs 104a-z to supply the high current.

For example, a first electric vehicle (not shown in FIG. 1) can include a charge port designed to receive a first connector (not shown in FIG. 1). The first connector can be connected to the EVSE 104a. The EVSE 104a can provide, to the first electric vehicle and via the first connector, AC power that is converted to DC power by the first electric vehicle to charge one or more batteries of the first electric vehicle. Likewise, a second electric vehicle (not shown in FIG. 1) can include a charge port designed to receive a second connector (not shown in FIG. 1). The second connector can be connected to the EVSE 104b. The EVSE 104b can provide, to the second electric vehicle and via the second connector, AC power that is converted to DC power by the second electric vehicle to charge one or more batteries of the second electric vehicle. The plurality of EVSEs 104a-z can provide power to any number of electric vehicles.

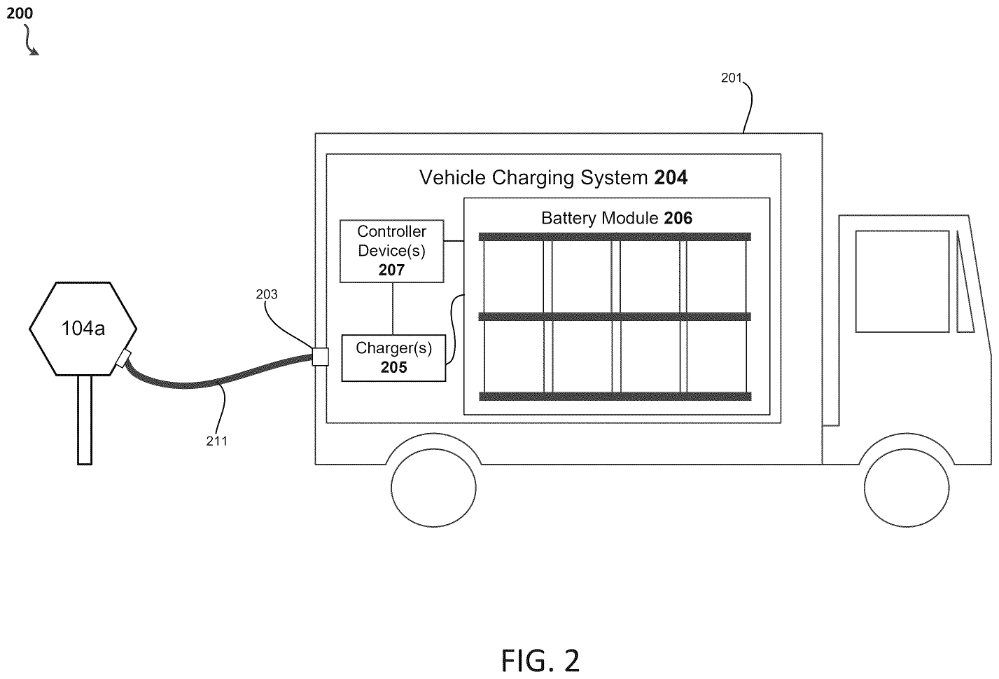

FIG. 2 shows an example system 200. The system 200 can include a vehicle 201, the EVSE 104a, and a connector 211. The vehicle 201 can include a vehicle charging system 204. The connector 211 can connect the EVSE 104a to the vehicle 201, such as to the vehicle charging system 204. For example, one end of the connector 211 can be connected to the EVSE 104a. The other end of the connector 211 can include a plug that is configured to be connected to, or plugged into, an input of 203 of the vehicle 201. The input 203 can be a charging port. Plugging the connector 211 into the input of 203 of the vehicle 201 can connect the EVSE 104a to the vehicle charging system 204. The connector 211 can be an existing high-power connector, such as a North American Charging Standard (NACS) connector, or any other connector that is capable of carrying the higher currents needed for AC power charging in excess of 19.2 kW.

The vehicle charging system 204 can include a battery module 206. The battery module 206 can include one or more large, structural battery packs that are configured to provide power to at least one component of the vehicle 201. The at least one component can include, for example, a main driver inverter, a motor, a steering pump, an AC compressor, a DC-DC converter, a cabin heater, a cooling system, a charger, an air compressor, an accessory inverter, and/or any other component of the vehicle 201. The battery module 206 may be connected to a power distribution unit (PDU). The battery module 206 can provide power to the at least one component of the electric vehicle via the PDU. The battery module 206 can include, for example, one, two, three, four, five, six, seven, eight, nine, or any other quantity of battery packs.

The vehicle charging system 204 can include one or more chargers 205. The charger(s) 205 can receive power, such as AC power, from the EVSE 104a via the connector 211. Each of the charger(s) 205 can include an AC-to-DC converter configured to convert at least a portion of the power supplied by the EVSE 104a to DC power. The charger(s) 205 can charge the battery packs of the battery module 206 using the DC power.

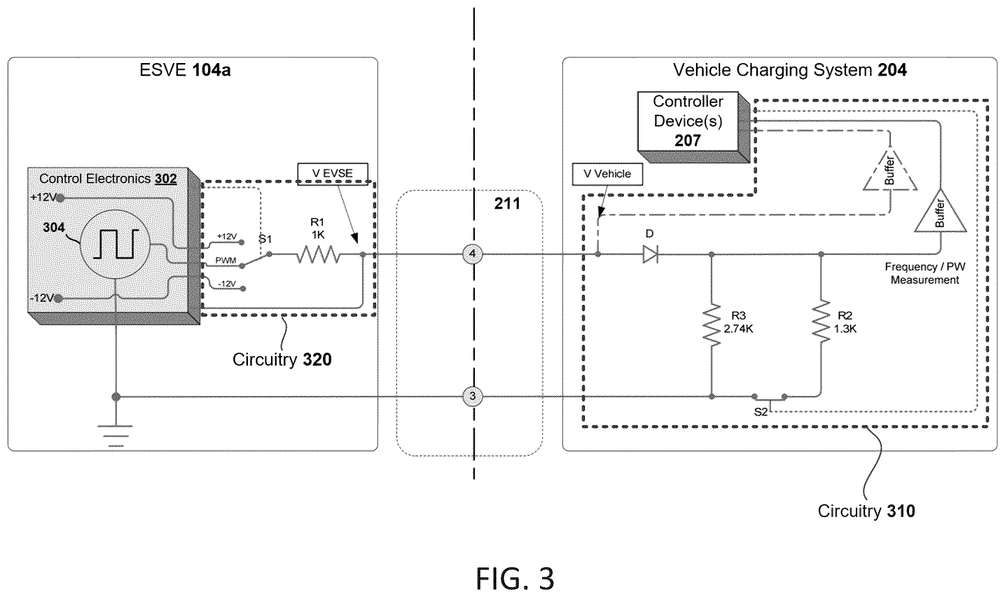

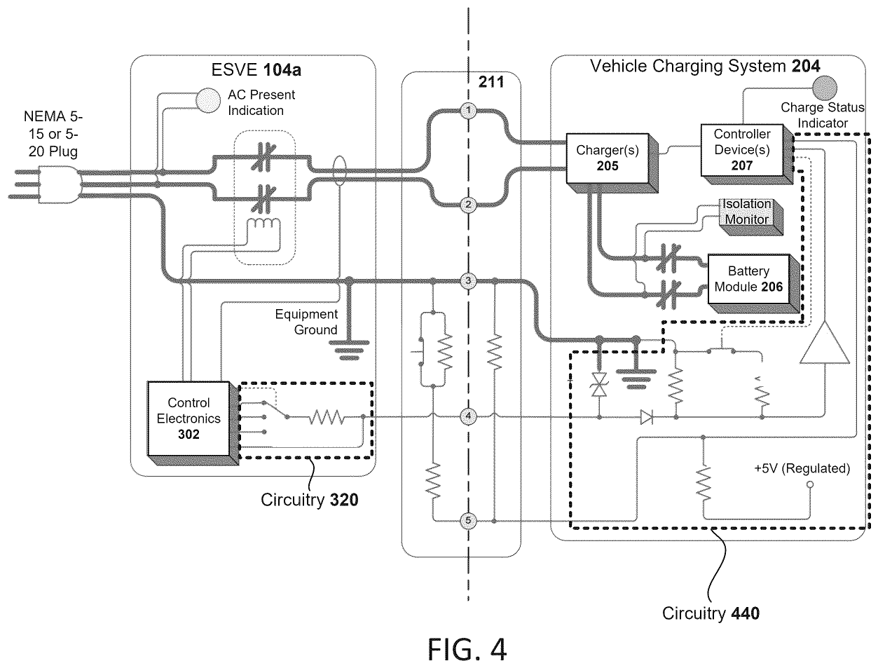

In embodiments, a handshake between the EVSE 104a and the vehicle charging system 204 can be performed to initiate the supply of power from the EVSE 104a to the vehicle charging system 204. Performing the handshake between the EVSE 104a and the vehicle charging system 204 can include sending, by the EVSE 104a and via the connector 211, a signal. The signal can indicate that the EVSE 104a is capable of high-power charging. For example, the signal can indicate that the EVSE 104a is configured to supply greater than 80 amps of current. The signal can be a power line communication signal, or the signal can be a control pilot signal associated with a special frequency that indicates that the EVSE is capable of high-power charging. If the vehicle charging system 204 detects or recognizes the signal, this can indicate that the vehicle charging system 204 is capable of receiving large amounts of current, such as greater than 80 amps of current. As such, the EVSE 104a can initiate the high-power charging process based on (e.g., in response to) the vehicle charging system 204 detecting or recognizing the signal. Initiating the high-power charging process can include initiating the supply of AC power to the vehicle charging system 204 via the connector 211. The handshake process and the signal are discussed in more detail below with regard to FIGS. 3-4.

In embodiments, the charger(s) 205 include a single charger. The single charger can include a single boost AC-to-DC converter. The single boost AC-to-DC converter can be configured to convert the AC power supplied by the EVSE 104a to DC power in excess of 19.2 kW. In other embodiments, the charger(s) 205 include a plurality of chargers. Each of the plurality of chargers can include its own AC-to-DC converter, such as a 19.2 kW AC-to-DC converter.

The vehicle charging system 204 can include at least one controller device(s) 207. The controller device(s) 207 can include one or more processors and memory storing instructions that, when executed by the one or more processors, cause the controller device(s) 207 to load balance the plurality of AC-to-DC converters. To load balance the plurality of AC-to-DC converters, the controller device(s) 207 can determine a power requested by the battery pack(s) of the battery module 206. The controller device(s) 207 can further determine a power to be supplied by the EVSE 104a. The controller device(s) 207 can determine an efficiency curve associated with each of the plurality of AC-to-DC converters. The controller device(s) 207 can calculate a power loss associated with each of a plurality of allocations of the plurality of AC-to-DC converters. The controller device(s) 207 can calculate the power loss associated with each of the plurality of allocations of the plurality of AC-to-DC converters based on (e.g., using) the efficiency curve associated with each of the plurality of AC-DC converters. The controller device(s) 207 can determine the allocation of the plurality of allocations that is associated with the smallest power loss. The controller device(s) 207 can control the chargers 205 to load balance the plurality of AC-DC converters based on the allocation associated with the smallest power loss.

FIG. 3 shows an example connection between the EVSE 104a and the vehicle charging system 104. The EVSE 104a can include control electronics 302 and circuitry 320. The control electronics 302 can include an oscillator 304. The vehicle charging system 204 can include the controller device(s) 207 and circuitry 310.

As described above, a handshake between the EVSE 104a and the vehicle charging system 204 can be performed to initiate the supply of power from the EVSE 104a to the vehicle charging system 204. Performing the handshake between the EVSE 104a and the vehicle charging system 204 can include sending, by the EVSE 104a and via the connector 211, a signal. The signal can be a control pilot signal. The control electronics 302 can send, via circuitry 320, the control pilot signal. For example, the control electronics 302 can send the control pilot signal to the circuitry 310 via control pilot line 4 shown in FIG. 3. The control pilot signal can be a unique signal that indicates, to the vehicle charging system 204, that the EVSE 104a is capable of supplying more than 80 amps of standard current. For example, the oscillator 304 can be modified to send the control pilot signal at a special frequency that indicates, to the vehicle charging system 204, that the EVSE 104a is capable of supplying more than 80 amps of standard current.

If the circuitry 310 and/or the controller device(s) 207 of the vehicle charging system 204 detect or recognize the control pilot signal, this can indicate that the vehicle charging system 204 is capable of receiving more than 80 amps of standard current. The circuitry 310 and/or the controller device(s) 207 of the vehicle charging system 204 can detect or recognize the control pilot signal based on detecting or recognizing the special frequency of the control pilot signal. If the vehicle charging system 204 is capable of receiving more than 80 amps of standard current, the EVSE 104a can initiate the high-power charging process.

FIG. 4 shows an example connection between the EVSE 104a and the vehicle charging system 204. The EVSE 104a can include the control electronics 302 and the circuitry 320. The vehicle charging system 204 can include the controller device(s) 207 and circuitry 440.

As described above, a handshake between the EVSE 104a and the vehicle charging system 204 can be performed to initiate the supply of power from the EVSE 104a to the vehicle charging system 204. Performing the handshake between the EVSE 104a and the vehicle charging system 204 can include applying, by the EVSE 104a and via the connector 211, a signal. The signal can be a special coded power line communication (PLC) signal. The control electronics 302 can apply the PLC signal on one or more of the power line 1, the control pilot line 4, the proximity detection line 5, and the ground line 3 shown in FIG. 4. If the vehicle charging system 204 recognizes or understands the special coded PLC signal, this can indicate that the vehicle charging system 204 is capable of receiving more than 80 amps of standard current. If the vehicle charging system 204 is capable of receiving more than 80 amps of standard current, the vehicle charging system 204 can send a recognition signal to the EVSE 104a. The EVSE 104a can initiate the high-power charging process based on the recognition signal.

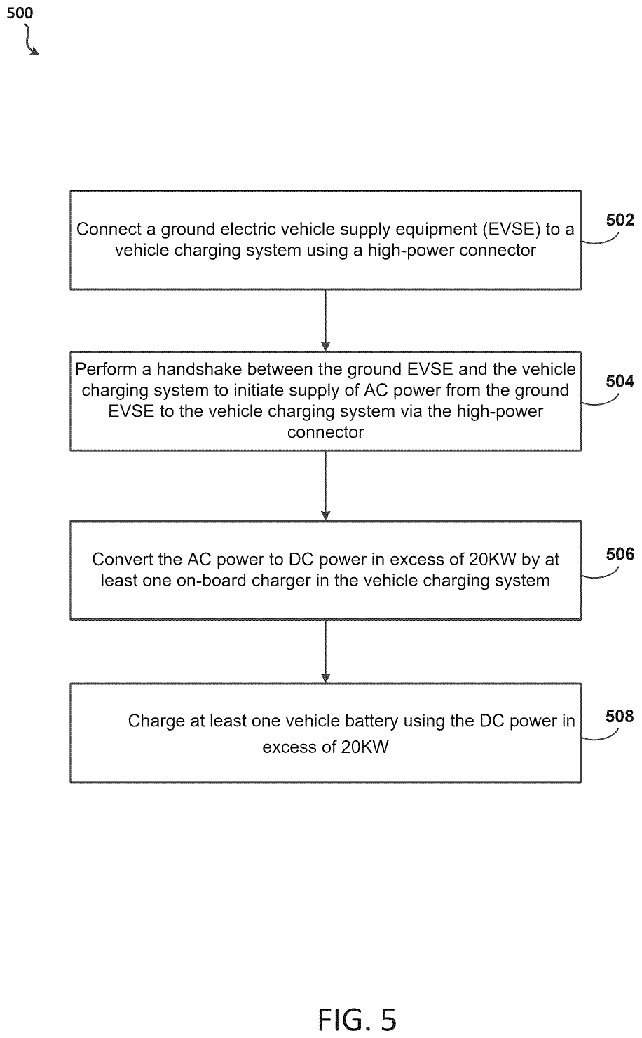

FIG. 5 shows a method 500 of high-power DC charging of at least one vehicle battery (e.g., the battery pack(s) of the battery module 206). At operation 502, an EVSE (e.g., EVSE 104a) is connected to a vehicle charging system (e.g., vehicle charging system 204) using a high-power connector (e.g., connector 211). The high-power connector can be a NACS connector.

At operation 504, a handshake is performed between the EVSE and the vehicle charging system. The handshake can be performed to initiate supply of AC power from the EVSE to the vehicle charging system via the high-power connector. The handshake can be performed to determine whether the vehicle charging system is capable of receiving a large supply of current, such as greater than 80 amps of current, from the EVSE. If the vehicle charging system is capable of receiving the large supply of current from the EVSE, the EVSE can begin supplying AC power in excess of 19.2 kW to the vehicle charging system via the high-power connector. Conversely, if the vehicle charging system is not capable of receiving the large supply of current from the EVSE, the EVSE can begin supplying less than or equal to 19.2 kW of AC power to the vehicle charging system via the high-power connector.

At operation 506, the AC power is converted to DC power. For example, the AC power in excess of 19.2 kW can be converted to DC power in excess of 19.2 kW. The AC power can be converted to DC power by at least one on-board charger (e.g., charger(s) 205) in the vehicle charging system. At operation 508, the at least one vehicle battery can be charged using the DC power in excess of 20 KW.

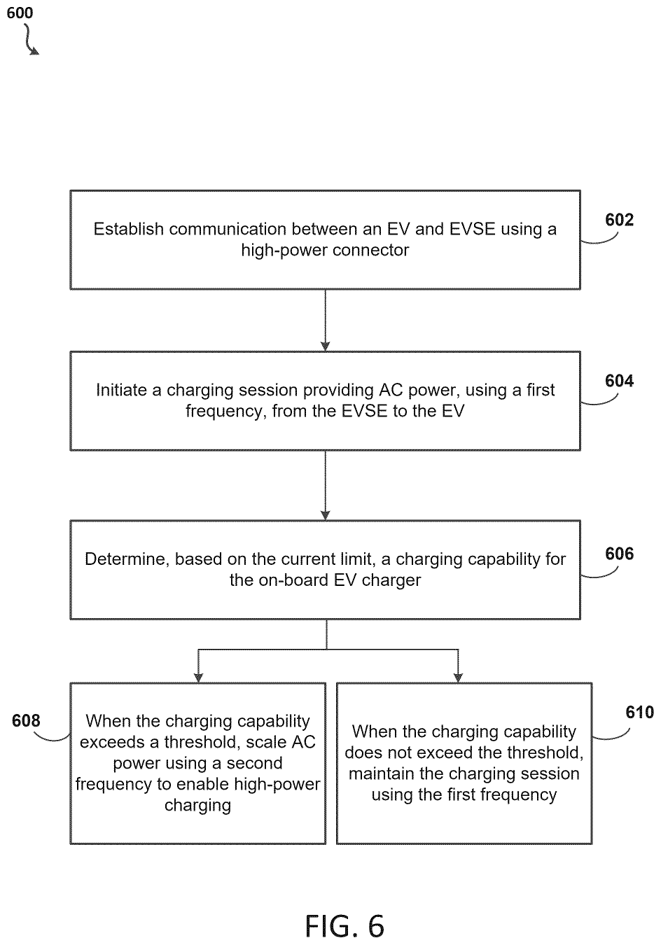

FIG. 6 shows a method 600 of load balancing multiple on-board chargers (e.g., chargers 105) in a high-power DC charging system. Each of the on-board chargers can include its own AC-to-DC converter, such as a 19.2 kW AC-to-DC converter. The method 600 can be performed, for example, by a controller device (e.g., the controller device(s) 207). At operation 602, a power requested by at least one vehicle battery (e.g., the battery pack(s) of the battery module 206) is determined. A power to be supplied by an EVSE (e.g., EVSE 104a) to a vehicle charging system (e.g., vehicle charging system 104) is determined.

At operation 604, an efficiency curve associated with each of the plurality of AC-DC converters is determined. At operation 606, a power loss associated with each of a plurality of allocations of the plurality of AC-to-DC converters is determined. The power loss can be determined based on (e.g., using) the efficiency curve associated with each of the plurality of AC-DC converters. At operation 608, the plurality of AC-DC converters is load balanced. The plurality of AC-DC converters is load balanced based on the allocation of the plurality of allocation associated with the smallest power loss.

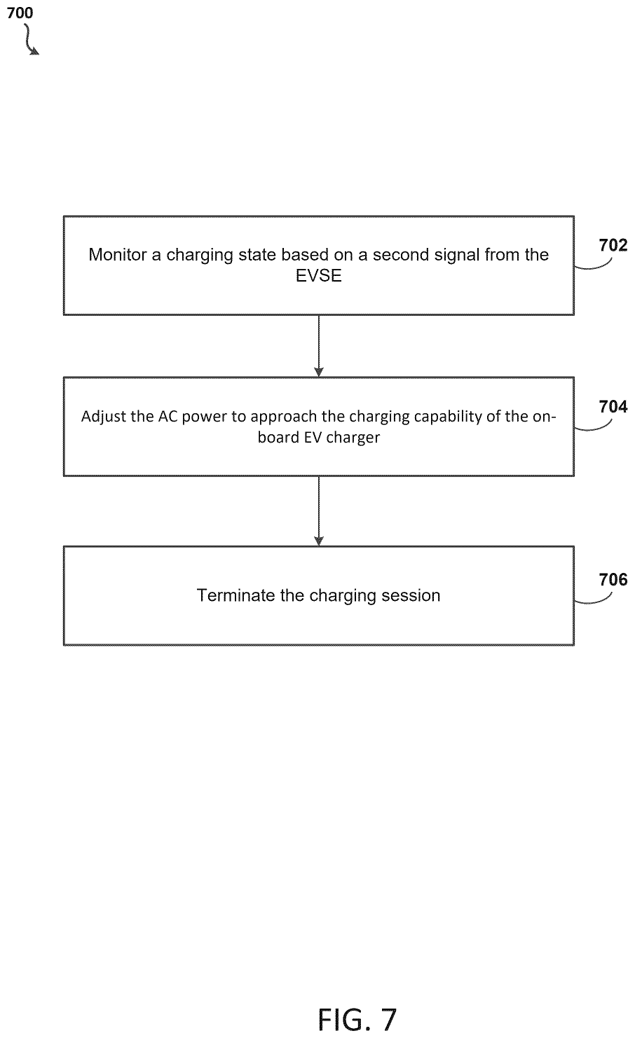

FIG. 7 shows a method 700 of performing a handshake in a high-power DC charging system. At 702, a signal is sent. The signal is sent by an EVSE (e.g., EVSE 104a). The signal can indicate that the EVSE is a high-power ESVE. For example, the signal can indicate that the EVSE can supply greater than 80 amps of current. The signal is sent to a vehicle charging system (e.g., vehicle charging system 104). If the vehicle charging system is a high-power vehicle charging system, such as a vehicle charging system capable of receiving greater than 80 amps of current from the EVSE, the vehicle charging system can detect the signal. At 704, the signal is detected by the vehicle charging system.

At 706, a supply of AC power from the EVSE to the vehicle charging system via a high-power connector (e.g., the connector 211) is initiated. The supply of AC power from the EVSE to the vehicle charging system can be initiated based on (e.g., in response to) the signal being detected by the vehicle charging system. For example, the EVSE can begin supplying AC power in excess of 19.2 kW to the vehicle charging system via the high-power connector. Conversely, if the vehicle charging system is not capable of receiving the large supply of current from the EVSE, the vehicle charging system may not recognize the signal. If the vehicle charging system does not recognize the signal, the EVSE can begin supplying less than or equal to 19.2 kW of AC power to the vehicle charging system via the high-power connector.

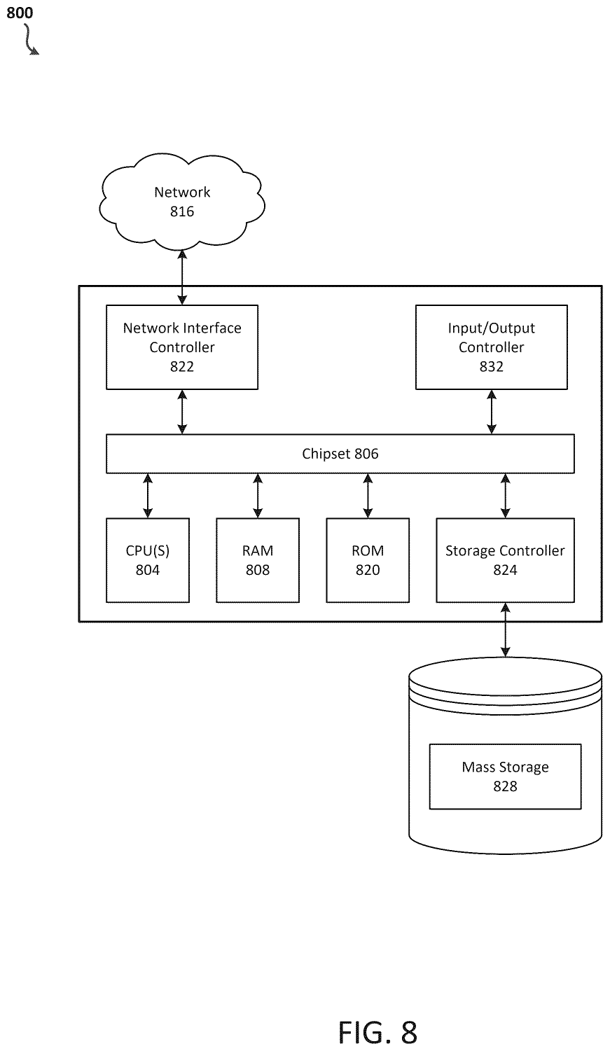

FIG. 8 depicts a computing device that may be used in various aspects, such as any of the devices depicted in FIGS. 2-4. For example, the controller device(s) 207 can each be implemented in an instance of a computing device 800 of FIG. 8.

The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 5-7.

The computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like. The CPU(s) 804 may be augmented with or replaced by other processing units, such as GPU(s). The GPU(s) may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random access memory (RAM) 808 used as the main memory in the computing device 800. The chipset 806 may further provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems through local area network (LAN) 816. The chipset 806 may include functionality for providing network connectivity through a network interface controller (NIC) 822, such as a gigabit Ethernet adapter. A NIC 822 may be capable of connecting the computing device 800 to other computing nodes over a network 816. It should be appreciated that multiple NICs 822 may be present in the computing device 800, connecting the computing device to other types of networks and remote computer systems.

The computing device 800 may be connected to a mass storage device 828 that provides non-volatile storage for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 828 by detecting the physical states or characteristics of one or more particular locations within the physical storage units.

In addition to the mass storage device 828 described above, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described above. The computing device 800 may have access to computer-readable storage media storing computer-executable instructions, which, when executed by the computing device 800, may perform the methods described in relation to FIGS. 5-7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These drawings may not be drawn to scale and may not precisely reflect structure or performance characteristics of any given embodiment and should not be interpreted as defining or limiting the range of values or properties encompassed by example embodiments.

As used in the specification and the appended claims, ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of high-power direct current (DC) charging of at least one vehicle battery, the method comprising:
connecting an electric vehicle supply equipment (EVSE) to a vehicle charging system using a high-power connector;
performing a handshake between the EVSE and the vehicle charging system to initiate supply of AC power from the EVSE to the vehicle charging system via the high-power connector; and
converting the AC power to DC power in excess of 19.2 kW by at least one on-board charger in the vehicle charging system; and
charging at least one vehicle battery using the DC power in excess of 19.2 kW.

2. The method of claim 1, wherein the at least one on-board charger comprises a plurality of AC-DC converters.

3. The method of claim 2, wherein the vehicle charging system comprises a controller device, the controller device comprising:
one or more processors; and
memory storing instructions that, when executed by the one or more processors, cause the controller device to load balance the plurality of AC-to-DC converters.

4. The method of claim 3, wherein the instructions that, when executed by the one or more processors, cause the controller device to load balance the plurality of AC-to-DC converters cause the controller device to:
determine a power requested by the at least one vehicle battery and the EVSE;
determine an efficiency curve associated with each of the plurality of AC-to-DC converters;
based on the efficiency curve associated with each of the plurality of AC-to-DC converters, calculate a power loss associated with each of a plurality of allocations of the plurality of AC-DC converters; and
load balance the plurality of AC-to-DC converters based on the allocation of the plurality of allocation associated with the smallest power loss.

5. The method of any one of claims 2-4, wherein each of the plurality of AC-to-DC converters is a 19.2 kW AC-DC converter.

6. The method of claim 1, wherein the at least one on-board charger comprises a single boost AC-DC converter.

7. The method of any one of claims 1-6, wherein performing the handshake between the EVSE and the vehicle charging system comprises:
sending, by the EVSE via the high-power connector, a signal indicating that the EVSE is configured to supply greater than 80 amps of current; and
detecting the signal by the vehicle charging system.

8. The method of claim 7, wherein the EVSE comprises at least one circuit component or at least one processor configured to send the signal to the vehicle charging system.

9. The method of any one of claims 7-8, wherein the vehicle charging system comprises at least one circuit component or at least one processor configured to detect the signal.

10. The method of any one of claims 7-9, wherein the signal comprises a power line communication signal.

11. The method of any one of claims 7-9, wherein the signal is a control pilot signal associated with a frequency that indicates that the EVSE is configured to supply greater than 80 amps of current.

12. The method of any one of claims 1-11, wherein the high-power connector is a North American Charging Standard (NACS) connector.

13. A high-power direct current (DC) charging system, the system comprising:
an electric vehicle supply equipment (EVSE);
a vehicle charging system comprising at least one on-board charger and at least one vehicle battery; and
a high-power connector configured to connect the ESVE to the vehicle charging system,
wherein the EVSE is configured to:
initiate supply of AC power from the EVSE to the vehicle charging system via the high-power connector based on a handshake performed between the EVSE and the vehicle charging system, and
wherein the at least one on-board charger is configured to:
convert the AC power to DC power in excess of 19.2 kW; and
charge the at least one vehicle battery using the DC power in excess of 19.2 kW.

14. The system of claim 13, wherein the at least one on-board charger comprises a plurality of AC-DC converters.

15. The system of claim 14, wherein the vehicle charging system comprises a controller device, the controller device comprising:
one or more processors; and
memory storing instructions that, when executed by the one or more processors, cause the computing device to load balance the plurality of AC-to-DC converters.

16. The system of any one of claims 14-15, wherein each of the plurality of AC-to-DC converters is a 19.2 kW AC-DC converter.

17. The system of claim 13, wherein the at least one on-board charger comprises a single boost AC-DC converter.

18. The system of any one of claims 13-17, wherein performing the handshake between the EVSE and the vehicle charging system comprises:
sending, by the EVSE and via the high-power connector, a signal indicating that the EVSE is configured to supply greater than 80 amps of current; and
detecting the signal by the vehicle charging system.

19. The system of claim 18, wherein the EVSE comprises at least one circuit component or at least one processor configured to send the signal to the vehicle charging system, and
wherein the vehicle charging system comprises at least one circuit component or at least one processor configured to detect the signal.

20. The system of any one of claims 18-19, wherein the signal comprises one of:
a power line communication signal; or
a control pilot signal associated with a frequency that indicates that the EVSE is configured to supply greater than 80 amps of current.
